(19) United States
(12) Patent Application Publication
(10) Pub. No.: US 2009/0079709 A1
(43) Pub. Date: Mar. 26, 2009

(54) SENSING DEVICE OF SURFACE ACOUSTIC WAVE TOUCH PANEL

(75) Inventors: SHANG-TAI YEH, TAIPEI COUNTY (TW); TENG-WEI HSIEH, TAIPEI COUNTY (TW)

Correspondence Address: ROSENBERG, KLEIN & LEE, 3458 ELLICOTT CENTER DRIVE-SUITE 101, ELLICOTT CITY, MD, 21043, US

(73) Assignee: EGALAX_EMPIA TECHNOLOGY INC., TAIPEI CITY (TW)

(21) Appl. No.: 11/858,392

(22) Filed: Sep. 20, 2007

(51) Int. Cl. G06F 3/043

(52) U.S. Cl. 345/177

(57) ABSTRACT

Described is a sensing device of a surface acoustic wave (SAW) touch panel having a new reflector columns and rows arrangement. As compared to the conventional design in the art where each of the reflector columns and rows are arranged from thinness to thickness, each of the arrangements of the reflector columns and rows herein is composed of a plurality of uniformly disposed reflectors having several sub-reflectors isolated with a gap or gaps. In this manner, a vibration wave transmitted through each of the reflector columns or rows can be reflected and then collected at a target transducer in an uniform pattern with respect to each portion of each of the reflecting columns and rows, thereby avoiding the problem encountered in the prior art.

### BACKGROUND OF THE INVENTION

1. Field of Invention

The present invention relates to a touch panel and particularly to a sensing device of a surface acoustic wave (SAW) touch panel in which the reflector columns and rows are each formed by uniformly arranged reflectors having a gap or gaps therein.

2. Description of the Related Art

Surface acoustic wave (SAW) touch panel is a touch panel which determines a touch position thereon by detecting a vibration signal at a target position. Specifically, a transducer having a piezoelectric material therein is utilized to converse an electric signal into the vibration signal and whether the vibration signal is blocked from transmission by a touch at the touch position is judged for the touch position determination by referring to the received vibration signal, generally an output electric signal conversed from the received vibration signal, at the target position of the touch panel.

FIG. 1A is a schematic diagram of a structure of a conventional SAW touch panel. As shown in FIG. 1A, the touch panel 10 comprises a screen area 11 and a reflecting area 12 having a sensing device 13 therein. The sensing device 13 has a first and second X-axis transducers 14a, 14b and a first and second Y-axis transducers 15a, 15b. The second X-axis and Y-axis transducers 14b, 15b are used to receive vibration signals Signal_V1 and Signal_V2 conversed from input electric signals Signal_Ei1 and Signal_Ei2 emitted from the first X-axis and Y-axis transducers 14a, 15a, respectively. In addition, the sensing device 13 also includes a first and second Y-axis reflecting units 16a, 16b and a first and second X-axis reflecting units 17a, 17b. Each of the first and second X-axis and Y-axis reflecting units 16a, 16b, 17a, 17b includes a plurality of reflector r each having the reflecting-in-part and transmitting-in-part characteristic. In this case, the vibration signals Signal V1 and Signal V2 required for detecting a touch position P on the X- and Y-axes of the screen area 11 can proceed along each of the first and second X-axis and Y-axis reflecting units 16a, 16b, 17a, 17b. In general, each of the reflectors r in the first and second X-axis and Y-axis reflecting units 16a, 16b, 17a, 17b is a line layer printed on a glass substrate of the touch panel 10 and thus has a low cost. In addition, the reflectors r in the first and second X-axis and Y-axis reflecting units 16a, 16b, 17a, 17b are arranged from thinnest to thickness (viewed from the proceeding directions of the vibrations Signal_V1 and Signal_V2, respectively), respectively. This is simply because when the thinness to thickness configuration of the reflecting units 16a, 16b, 17a, 17b is absent, the intensity of the vibration signals Signal_V1 and Signal_V2, undesirably becomes smaller as the vibration signals Signal_V1 and Signal_V2 proceed longer along a single respective X- or Y-axis reflecting units 16a, 16b, 17a, 17b, and thus the touch position sensing ability becomes weaker for the touch point P associated with the farer side of the single respective X- or Y-axis reflecting units 16a, 16b, 17a, 17b. Therefore, the thinness to thickness configuration is provided to each of the reflecting units 16a, 16b, 17a, 17b for compensation for this effect. FIG. 1B and FIG. 1C are waveform plots of Signal_Eo1 and Signal_Eo2 when the touch point P exists on and is absent from the SAW touch panel shown in FIG. 1A, respectively. As shown in FIG. 1B and FIG. 1C, Vy is the waveform of the output electric signal Signal_Eo1 and corresponds to an X-axis coordinate of the touch point P on the SAW touch panel 10. On the other hand, Vx is the waveform of the output electric signal Signal_Eo2 and corresponds to a Y-axis coordinate of the touch point P. It can be seen that the output electric signal Vx has a longer signal span than that of the output electric signal Vy. This is because the vibration signal Signal_V2 corresponding to the output electric signal Vx experiences a longer path than that of the vibration signal Signal_V1 corresponding to the output electric signal Vy. In FIG. 1C, there is a notch on the waveform of the output electric signal Vx and Vy, respectively, with which the touch position P may be determined. In addition, at the beginning of both the output electric signals Vy and Vx, there is a spike, which is resulted from the fact that the vibration signals Signal_V1 and Signal_V2 from the input electric signals Signal_Ei1 and Signal_Ei2 are directly received by the second X-axis transducer 14b and the second Y-axis transducer 15b via the second X-axis reflecting unit 17b and second Y-axis reflecting unit 16b.

However, the SAW touch panel 10 having the thinness to thickness configuration also has its demerits. Owing to the thinner arrangement portion of the reflectors at each of the reflecting units 16a, 16b, 17a, 17b, the touch position P may sometimes associate with between two neighboring reflectors in a single reflecting units 16a, 16b, 17a, 17b. In this case, the determination of the touch position P on the SAW touch panel 10 is not ideal enough.

In this regard, the present invention sets forth a sensing device of a SAW touch panel, which may well overcome the problem encountered in the prior art.

### SUMMARY OF THE INVENTION

It is, therefore, an object of the present invention to provide a sensing device of a surface acoustic wave (SAW) touch panel, so as to overcome the problem encountered in the prior art.

In accordance with an aspect of the present invention, the sensing device of a surface acoustic wave (SAW) touch panel comprises a transparent substrate taking a substantially rectangular shape, having a screen area and a reflecting area, and having a first X-axis and a second X-axis substantially parallel therewith and a first Y-axis and a second Y-axis substantially parallel therewith, the first and second X-axis and Y-axis each having two ends; a first X-axis transducer and a second X-axis transducer disposed at the reflecting area on the two ends of the first X-axis, respectively, and a first Y-axis transducer and a second Y-axis transducer disposed at the reflecting area on the two ends of the first Y-axis, respectively; and a first Y-axis reflecting unit, a second Y-axis reflecting unit, a first X-axis reflecting unit and a second X-axis reflecting unit, disposed on the reflecting area along the first X-axis, the second Y-axis, the first X-axis and the second X-axis, respectively, each of the first and second Y-axis reflecting units including a first number of reflectors and each of the first and second X-axis reflecting units including a second number of reflectors, wherein each reflector of the first and second X-axis and Y-axis reflecting units has a gap or gaps, so as to form a plurality of sub-reflectors therein.

In an embodiment, wherein the gap between the neighboring sub-reflectors of each reflector of the first and second X-axis and Y-axis reflecting units is dependent upon a material forming the first and second X-axis and Y-axis reflecting units, a relationship among the gaps of the sub-reflectors of the neighboring reflectors of the first and second X-axis and Y-axis reflecting units is also dependent upon the material forming the first and second X-axis and Y-axis reflecting units, and a relationship among the gaps of the sub-reflectors of the reflectors of the first and second X-axis and Y-axis reflecting units is determined by experiment.

Since the reflectors in the first and second X-axis and Y-axis reflecting units of the sensing area of the SAW touch panel are uniformly arranged, the problem which a touch point can not be effectively sensed on the same touch panel associated with the thinly distributed reflectors can be overcome.

### BRIEF DESCRIPTION OF THE DRAWINGS

The above and other objects of the present invention will become readily apparent by reference to the following detailed description when considered in conjunction with the accompanying drawings, wherein:

FIG. 1A is a schematic structure for illustrating how a touch position made on a conventional surface acoustic wave (SAW) touch panel is detected;

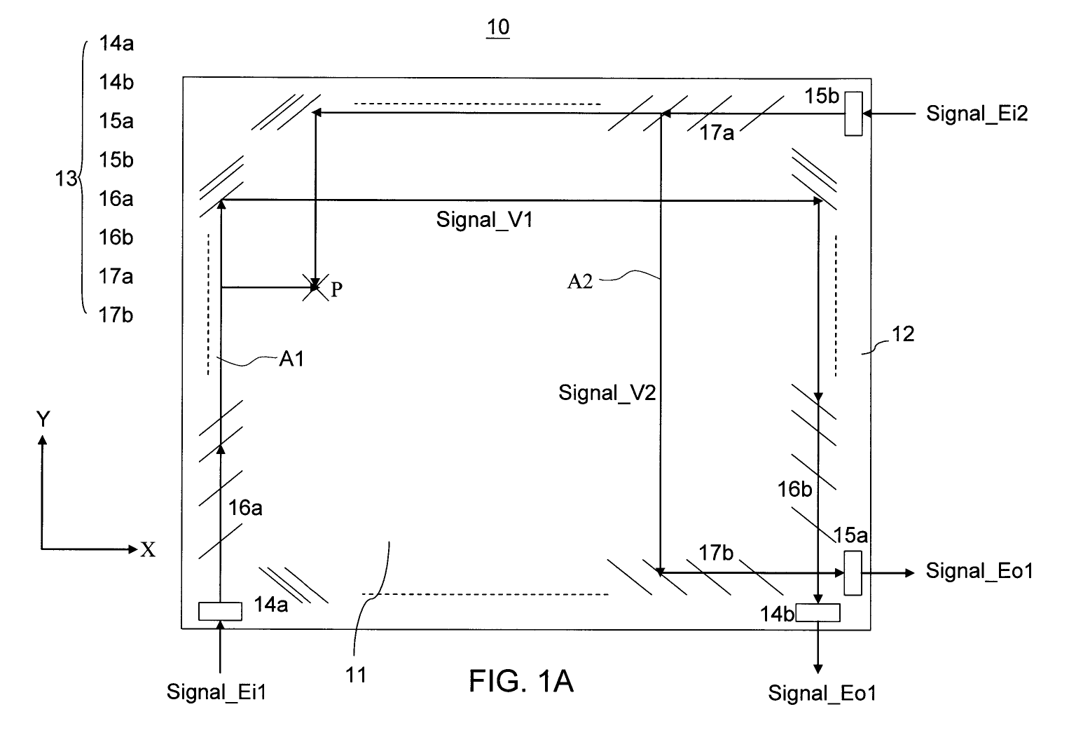

FIG. 1B is waveform plots of two output electric signals from the SAW touch panel shown in FIG. 1A when no touch input is impinged on the same, respectively;

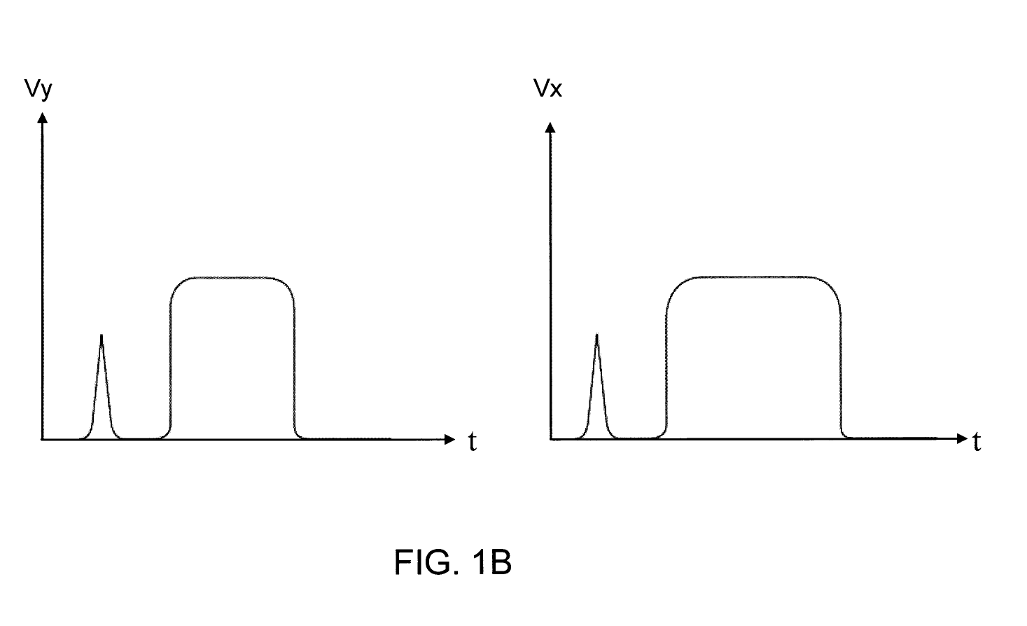

FIG. 1C is waveform plots of two output electric signals from the SAW touch panel shown in FIG. 1A when there is a touch input impinged on the same;

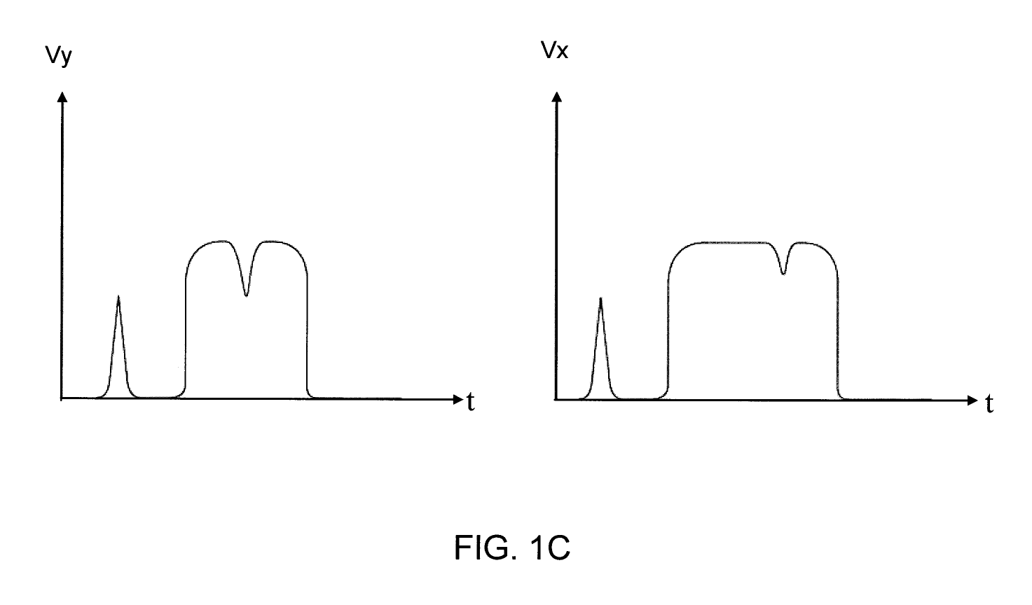

FIG. 2A is a schematic structure for illustrating how a touch position on a SAW touch panel according to the presenting invention is detected;

FIG. 2B is waveform plots of two output electric signals from the SAW touch panel shown in FIG. 2A when no touch input is impinged on the same, respectively; and

FIG. 2C is waveform plots of two output electric signals from the SAW touch panel shown in FIG. 2A when there is a touch input impinged on the same, respectively.

### DETAILED DESCRIPTION OF THE INVENTION

The present invention is a sensing device of a surface acoustic wave (SAW) touch panel according to the present invention, and will be described taken in the preferred embodiments with reference to the accompanying drawings.

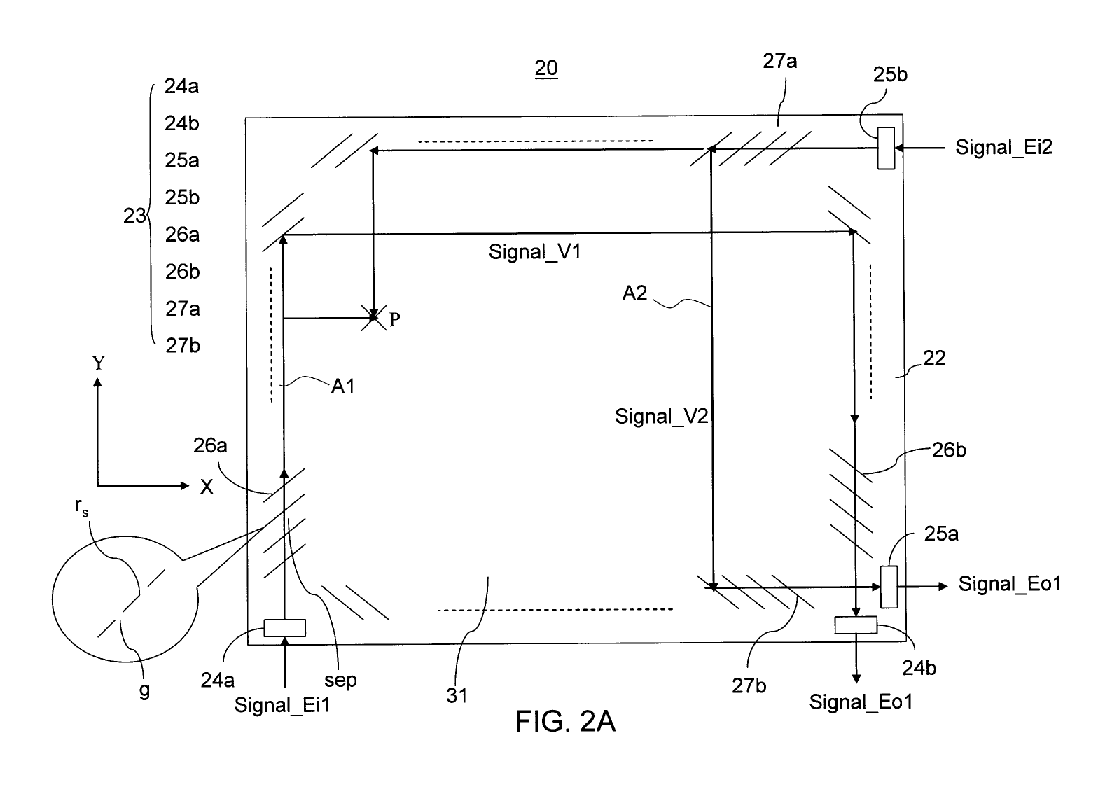

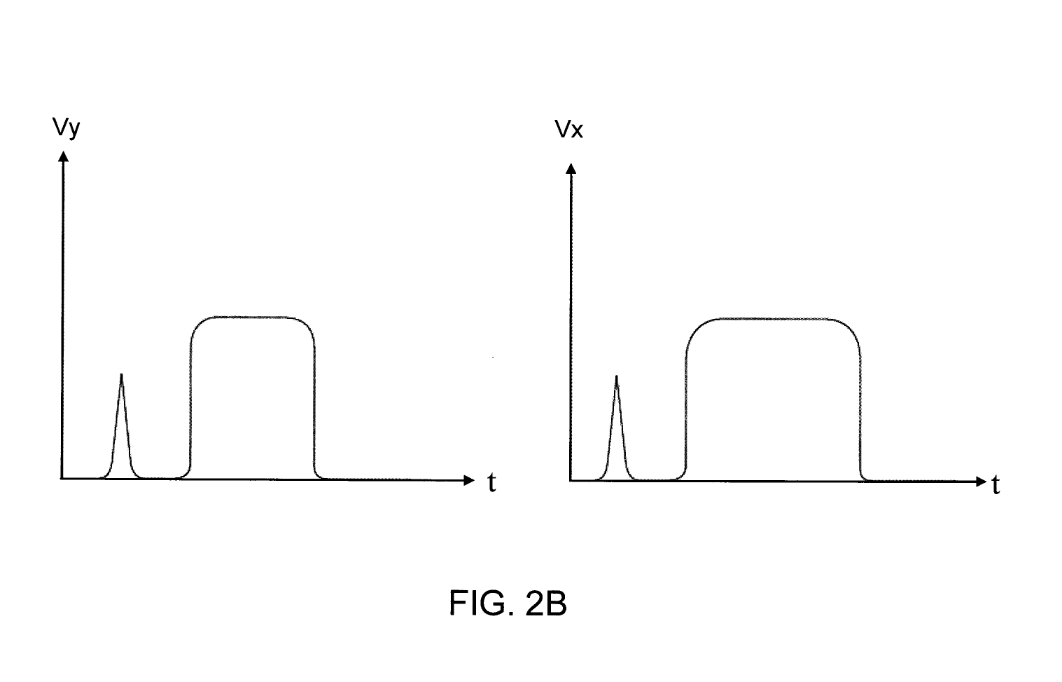

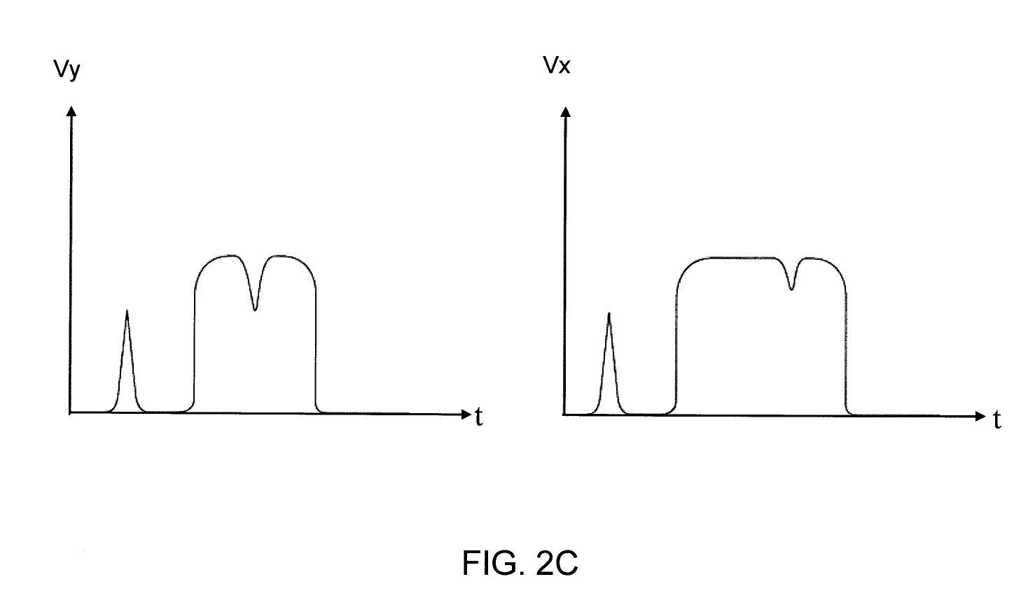

Referring to FIG. 2A, which a schematic structure for illustrating how a touch position on a SAW touch panel according to the present invention is detected. As shown, the SAW touch panel 20 is a rectangular device which may be measured with an X-axis and a Y-axis and has a screen area 21 and a reflecting area 22 at which a sensing device 23 is disposed. The sensing device 23 includes a first and second X-axis transducers 24a and 24b and a first and second Y-axis transducers 25a and 25b. The sensing area 23 further includes a first and second Y-axis reflecting units 26a and 26b and a first and second X-axis reflecting units 27a and 27b. The first and second Y-axis and X-axis reflecting units 26a, 26a, 27a, 27b are vertically or horizontally arranged circumferentially with respect to the screen area 21. The first and second Y-axis reflecting units 26a and 26b (also termed as the first and second reflecting columns herein) each includes a first number of reflectors r while the first and second X-axis reflecting units 27a and 27b (also termed as the first and second reflecting rows herein) each includes a second number of reflectors r. In addition, all the reflectors r each has the transmitting-in-part and reflecting-in-part characteristic and each has a plurality of sub-reflectors rₛ each separated from the neighboring one or ones among the plurality of sub-reflectors rₛ with a gap g.

In real operation, an electric signal Signal_Ei1 is inputted into the first X-axis transducer 24a of the SAW touch panel 20, in which the electric signal Signal_Ei1 is conversed into a vibration signal Signal_V1. The vibration signal Signal_V1 thus obtained then proceeds along the first Y-axis reflecting unit 26a where the vibration signal Signal_V1 is transmitted in part and reflected in part. The reflected portion of the vibration signal Signal_V1 is then further reflected by a corresponding reflector r in the second Y-axis reflecting unit 16b and finally received by the second X-axis transducer 24b after a proceeding path of the reflected vibration signal portion Signal_V1, depicted in FIG. 2A as A1, in which the vibration signal portion Signal_V1 is conversed into an output electric signal Signal_Eo1. Similarly but unconcurrently, an electric signal Signal_Ei2 is inputted to the SAW touch panel 20 at the first Y-axis transducer 25a, in which the input electric signal Signal_Ei2 is conversed into a vibration signal Signal_V2. The reflected portion of the vibration signal Signal_V2 is then further reflected by a corresponding reflector r in the second X-axis reflecting unit 17b and finally received by the second Y_axis transducer 25b after a proceeding path of the reflected vibration signal portion Signal_V2, depicted in FIG. 2A as A2, in which the vibration signal portion Signal_V2 is conversed into an output electric signal Signal_Eo2. Finally, the output electric signals Signal_Eo1 and Signal_Eo2 are relied upon to determine where the touch point P is located on the SAW touch panel 20 by referring to the input electric signals Signal_Ei1 and Signal_Ei2.

In the above, that the transducers 24a and 24b are operated at different time from that of the transducers 25a and 25b is made to prevent the vibration signals Signal_V1 and Signal_V2 from interfering with each other. Correspondingly, the first and second input electric signals Signal_Ei1 and Signal_Ei2 are supplied alternatively to the first X-axis and Y-axis transducers 24a and 25a. As such, any possible touch position on the SAW touch panel 20 can be continuously detected.

In addition, the output electric signals Signal_Eo1 and Signal_Eo2 above mentioned have the waveforms Vy and Vx shown in FIG. 2B, respectively.

When a touch position P appears on and contacts with the screen area 21 of the SAW touch panel 20, the proceeding paths of the first and vibration signals Signal_V1 and Signal_V2 associated with the touch position P are blocked, the first and second output electric signals Signal_V1 and Signal_V2 each has a decreased level Vy and Vx, respectively, shown in FIG. 2C. By referring to the point of time the decreased levels Vy and Vx appears, a coordinate (X, Y) of the touch position P contacted with the screen area 21 of the SAW touch panel 20 can be determined.

Since the sub-reflectors rs is present, the vibration signals Signal_V1 and Signal_V2 which may be reflected by the reflectors r located at a rear part of each of the first and second Y-axis and X-axis reflecting units 26a, 26a, 27a, 27b (viewed from the directions that the vibration signals Signal_V1 and Signal_V2 outputted from the transducers 24a and 25a, respectively) do not decrease. Namely, the vibration signals Signal_V1 and Signal_V2 reflected by the reflectors r located at the rear part of each of the first and second Y-axis and X-axis reflecting units 26a, 26a, 27a, 27b (viewed from the same directions) do not decrease is simply because the reflectors r of each of the first and second Y-axis and X-axis reflecting units 26a, 26a, 27a, 27b each has the gaps g and the vibration signals Signal_V1 and Signal_V2 can better transmit through a fore part of each of the first and second Y-axis and X-axis reflecting units 26a, 26a, 27a, 27b to the rear part of the same.

Furthermore, the neighboring reflectors r of each of the first and second Y-axis and X-axis reflecting units 26a, 26a, 27a, 27b may be arranged with an equidistance, such as a separation sep, without losing the ability to detect the touch position P on the SAW touch panel 20, owing to the provision of the sub-reflectors rₛ. In this manner, all the possible touch positions P on the SAW touch panel 20 can be located at the proceeding paths of the reflected portions of the vibration signals Signal_V1 and Signal_V2, respectively. Accordingly, any possible touch position P on the SAW touch panel 20 can be well detected, as contrasted to the case in the prior art where some possible touch positions P may appear between the two neighboring proceeding paths A1 or/and A2 with a relatively larger separation and thus can not be perfectly detected.

In a preferred embodiment, the separation sep of each of the neighboring reflectors of the first and second Y-axis and X-axis reflecting units 26a, 26a, 27a, 27b is set to be equal. Each of the neighboring sub-reflectors rₛ of each of the first and second Y-axis and X-axis reflecting units 26a, 26a, 27a, 27b and a relationship of the gaps among each of the sub-reflectors rₛ of the reflectors r of the first and second Y-axis and X-axis reflecting units 26a, 26a, 27a, 27b are dependent upon a material forming each of the reflectors r. Further, any one of all the gaps g has an optimal relationship with the other gaps of the reflectors r in the first and second Y-axis and X-axis reflecting units 26a, 26a, 27a, 27b obtained by experiment.

In addition, each of the reflectors r has generally the form of a reflecting line layer made of ink. The reflecting line layer is fabricated on a transparent substrate (now shown), like the sensing device 23 by a printing method. In a preferred embodiment, the transparent substrate is a transparent glass substrate.

In addition, the first and second input electric signals Signal_Ei1 and Signal_Ei2 can be supplied by a single external signal source (now shown). At this time, a switch may be provided to switch alternatively the signal external signal source to be the first and second input electric signals Signal_Ei1 and Signal_Ei2. In addition, each of the first and second input electric signals Signal_Ei1 and Signal_Ei2 takes the form of a signal consisting of bursts.

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

What is claimed is:

1. A sensing device of a surface acoustic wave (SAW) touch panel, comprising:
a transparent substrate taking a substantially rectangular shape, having a screen area and a reflecting area, and having a first X-axis and a second X-axis substantially parallel therewith and a first Y-axis and a second Y-axis substantially parallel therewith, the first and second X-axis and Y-axis each having two ends;
a first X-axis transducer and a second X-axis transducer disposed at the reflecting area on the two ends of the first X-axis, respectively, and a first Y-axis transducer and a second Y-axis transducer disposed at the reflecting area on the two ends of the first Y-axis, respectively; and
a first Y-axis reflecting unit, a second Y-axis reflecting unit, a first X-axis reflecting unit and a second X-axis reflecting unit, disposed on the reflecting area along the first X-axis, the second Y-axis, the first X-axis and the second X-axis, respectively, each of the first and second Y-axis reflecting units including a first number of reflectors and each of the first and second X-axis reflecting units including a second number of reflectors, wherein each reflector of the first and second X-axis and Y-axis reflecting units has a gap or gaps, so as to form a plurality of sub-reflectors therein.

2. The sensing device as claimed in claim 1, wherein each of the first and second X-axis and Y-axis reflecting units has an equal distance between two neighboring reflectors thereof.

3. The sensing device as claimed in claim 1, wherein the gap between the neighboring sub-reflectors of each reflector of the first and second X-axis and Y-axis reflecting units is dependent upon a material forming the first and second X-axis and Y-axis reflecting units, a relationship among the gaps of the sub-reflectors of the neighboring reflectors of the first and second X-axis and Y-axis reflecting units is also dependent upon the material forming the first and second X-axis and Y-axis reflecting units, and a relationship among the gaps of the sub-reflectors of the reflectors of the first and second X-axis and Y-axis reflecting units is determined by experiment.

4. The sensing device as claimed in claim 1, wherein each of the reflectors in each of the first and second X-axis and Y-axis reflecting units is a reflecting line layer.

5. The sensing device as claimed in claim 4, wherein the reflecting line layer is an ink layer printed on the transparent substrate.

6. The sensing device as claimed in claim 5, wherein the transparent substrate is a transparent glass substrate.
